(19) United States
(12) Patent Application Publication
(10) Pub. No.: US 2002/0152127 A1
(43) Pub. Date: Oct. 17, 2002

(54) Tightly-coupled online representations for geographically-centered shopping complexes

(75) Inventors: Rick Allen Hamilton II, Charlottesville, VA (US); Carl Phillip Gusler, Austin, TX (US)

Correspondence Address: Robert H. Frantz, P.O. Box 23324, Oklahoma City, OK, 73123-2334, US

(73) Assignee: International Business Machines Corporation, Armonk, NY

(21) Appl. No.: 09/834,112

(22) Filed: Apr. 12, 2001

(51) Int. Cl. G06F 17/60

(52) U.S. Cl. 705/26

(57) ABSTRACT

An enhanced sensory experience coupled to an online shopping mall web site which creates an apparent geographical coupling between cyberstores within an online mall, and enables online store proprietors to control shopping environment factors using presentation of visual images and audible sounds relevant and coordinated to a shopper's “position” within a cybermall. As a shopper moves through a cybermall, graphical images of mall hallways and store facades are presented in a geographically logical sequence, with hot spots in the images defining entry points to enter the stores. As stores are entered, specific images of store interiors are provided, allowing each store to control and generate an environment within their own store. During the entire experience, relevant audible sounds are provided to the shopper such as general mall hallway sounds while in the mall, and store-specific background sounds and music while in a selected store.

### BACKGROUND OF THE INVENTION

1. Field of the Invention

This invention relates to the technologies of online shopping and commerce, and especially to the graphical technologies for representing online commerce facilities, organization, and navigation of online shopping centers.

2. Description of the Related Art

In today's competitive commercial and retail environment, owners and employees of physical “bricks and mortar” stores often view web-based commerce as competition. For example, a local bookstore owner recognizes such online proprietors as Amazon.com as a direct competitor. In some instances, retail franchise owners may view the online web site of the same franchise name, albeit operated by the master franchiser, as even more direct competition because there is a high level of overlap in inventory as well as identical name brand recognition.

Many online shopping “malls”, or “cybermalls”, have been developed as web-based purchasing has become culturally acceptable to consumers and as online purchasing security concerns have been addressed. However, these online shopping malls are typically little more than a group of hyperlinked web sites or portions of web sites, accessible through a common “home” page. Turning to FIG. 1, the well-known arrangement of web browser computers (1) and web servers (5) interconnected by the Internet or World Wide Web (3) or intranets (6). Typically, the browser computer (1) comprises a personal computer running a web browser software such as Netscape's Navigator, using a protocol such as Transmission Control Protocol/Internet Protocol (TCP/IP) running over a dial-up modem connect, digital subscriber line (DSL), cable modem, or the like. The web server (5) typically consists of a web platform, such as IBM's Websphere product, and communicates to browser computers using Hyper Text Transfer Protocol (HTTP) by transmitting web objects including Hyper Text Markup Language Documents (HTML), graphic images (GIF, JPEG, etc.), audio and video clips (AVI, WAV, etc.), JAVA applets, and other common types of content objects. Hyperlinking for addressing these objects is also well known a prevalent throughout today's web environment.

Cybermalls exist currently as a loose collection of store web sites, for example, a grouping of online shoe stores accessible by a single hop or “click” from a common access point. Some cybermalls are collections of store sites offering products with geographical relationships, such as products made only in New England, Id., or Hawaii. Many bricks-and-mortar malls provide a variety of store types, including some specialty stores, some department stores, and meeting places such as food courts and restaurants, as do many cybermalls.

During the 1980's when automatic teller machines (ATM) became widely available for bank customers, banks found that their ability to distinquish themselves from competitors was subsequently reduced as their clients visited their physical facilities less and less often, favoring to make most transactions with a convenient ATM. For example, a first bank may have established a very respectable, reliable image, with bank lobbies furnished in luxurious furniture, marble, and artwork. Clients who frequent this bank's lobby are given an impression that the bank is well established, and higher fees may be more acceptable. Another bank, perhaps a credit union, may adopt a more Spartan image, with more practical and cost effective furniture, such as “cube” furniture, in order to project an image of efficiency and cost effectiveness.

However, as bank clients began to conduct the vast majority of their banking transactions with an ATM, they visited the bank's actual facilities very seldom and in some cases never. So, the client's view of the bank became that of the ATM terminal not the bank's lobby or building. Since there is very little difference between the appearances of ATM terminals, banks subsequently found it very difficult to distinguish their desired image from their competitors images.

So has become the problem for retailers in malls and online. While in physical form in a mall, a retailer may use choices of lighting, display materials and designs, background sounds and music, and store facade design to generate an image, it is very difficult to present the same image in a distinguishing manner through a web browser. As such, some online-only retailers, such as Amazon.com, have been able to quickly establish an image comparable and competitive with bricks-and-mortar retailers such as Borders and Barne's and Noble.

Presently, online marketplaces are frequently set up in one of two fundamental ways. Firstly, consider that stores and malls may be presented in their entirety as a single domain, with possible divisions between departments (e.g., men's wear, households, etc), as shown in FIG. 2. A mall home page (21) may contain a group of hyperlinks to various store home pages (23, 24, and 25), which in turn provide hyperlinks to department pages (26, 27, 28, 29, 200, and 201). The tree structure of these sites are well known and are not unlike the tree structures of other, non-retail web sites.

Secondly, online malls are often organized so that visiting one “mall-front” shows lists of stores of possible interest to the visitor, and often provide search facilities (36) based on store names or product categories, as shown in FIG. 3. In this example, the web browser framer (31) which is displayed on a portion (30) of a web browsing device's display provides BACK and FORWARD navigation buttons (33, 34), and a location or address entry (32). Some online malls, as well as some online convention halls (wherein virtual convention “booths” are presented), provide a map-like view (37) of the virtual “layout” of the mall. This usually does not correspond to a real mall design, but is presented to enhance the browser's shopping experience. The cursor or pointer (35) may be used by the browser to select an icon, button, or store on the map. Again, similar to the first method described, these stores may either be organized as separate domains or accessible through the same domain. Again, too, it is evident that this organization of information is not unlike organization of information on other types of non-retail web sites. Thus, the “look and feel” of visiting these types of online malls is not much different that that of visiting other types of web sites, and certainly does not parallel the full sensory experience of visiting a real, bricks-and-mortar mall. Current online malls have little commonality or coherence to result in return visits, known as “stickiness”, when compared to real shopping malls.

Many of the carefully selected factors in real stores are lost in the online shopping experience. A mall operator may group certain types of stores based on a crossover business potential, such as placing a linen store, a bath products store, and a women's dress shop in close proximity to each other to target female shoppers. Within “cyberstores” themselves, other factors have not been translated well to the online experience, such as the use of background music and sounds to set a mood or environment to complement a store's or department's product lines.

Therefor, there is a need in the art for a system and method to more realistically provide online shopping mall experiences to online shoppers via common web browsing devices. This system and method should preferably provide a correlation or at least the appearance of a correlation between physical or sensory characteristics of stores within the mall and stores themselves, including but not limited to, accurate visual presentations of the mall store fronts, hallways, and store interiors, audible sounds of the mall spaces and stores, and a sense of physical placement within a mall area. This method and system should be equally applicable to representation of “real” or existing shopping malls, as well as virtual malls.

### BRIEF DESCRIPTION OF THE DRAWINGS

The following detailed description when taken in conjunction with the figures presented herein provide a complete disclosure of the invention.

FIG. 1 illustrates the well-known arrangement of web browser devices and web servers.

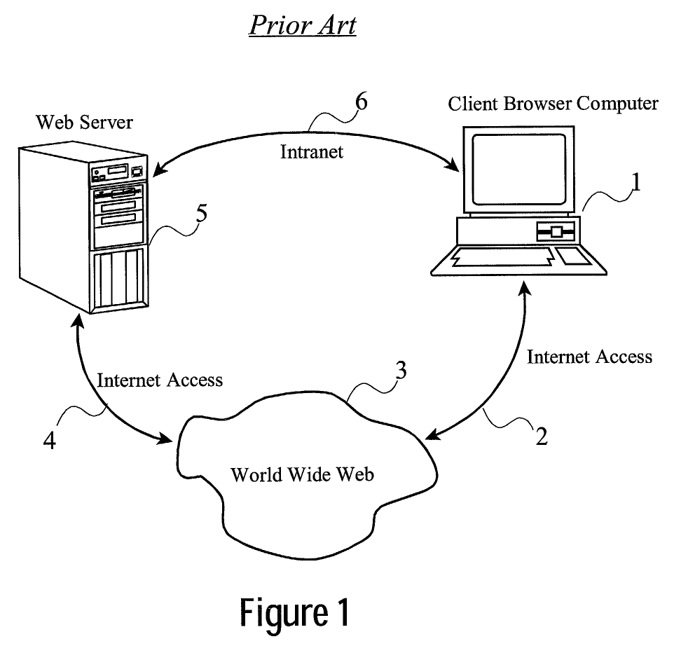

FIG. 2 shows the typical tree-like structure or organization of online mall information.

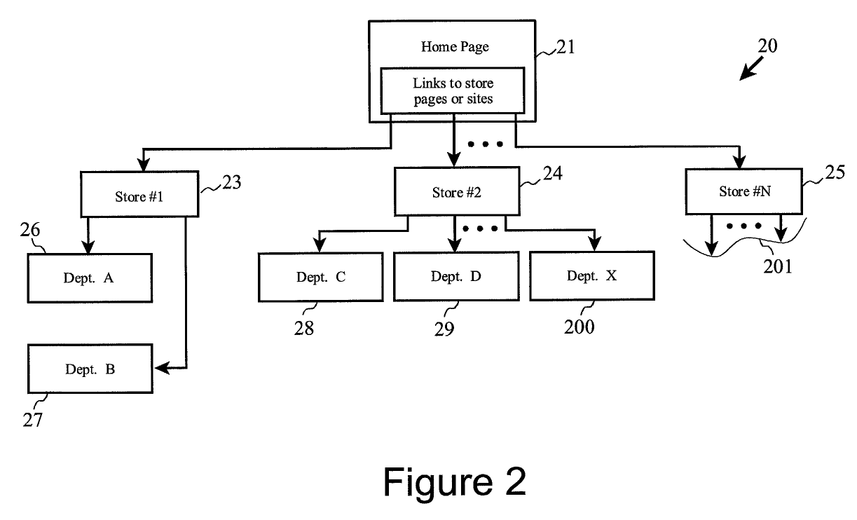

FIG. 3 shows a typical online mall front page with a “map” of a virtual mall.

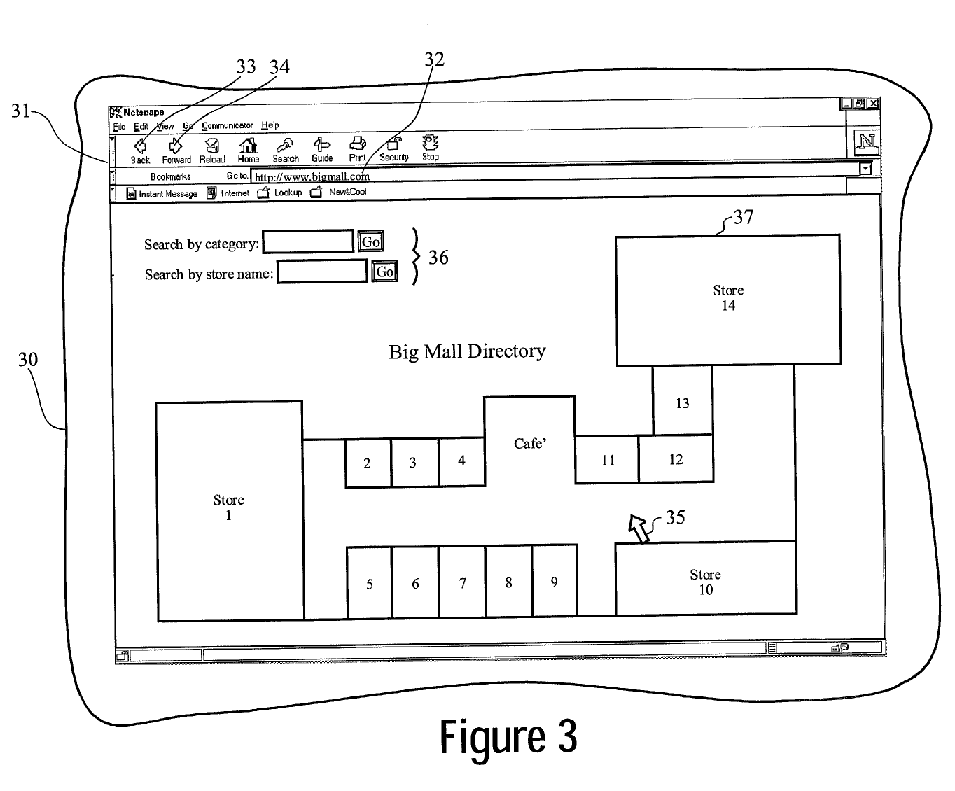

FIG. 4 discloses the enhanced view of an online mall front page including a “you are here” indicator, and an icon to select the full sensory presentation of the mall shopping visit.

FIG. 5 shows an example presentation of a visual image from a particular vantage point or position within a cybermall in which multiple adjacent store fronts may been seen.

FIG. 6 sets forth the common arrangement of components of web servers and web browser devices.

FIG. 7 illustrates the logical process performed by the invention.

FIG. 8 shows the object model for the system and method of the invention.

### SUMMARY OF THE INVENTION

The present invention provides an enhanced sensory experience coupled to an online shopping mall web site to which create an apparent geographical coupling between cyberstores within the online mall and to enable store proprietors to control shopping environment factors. Using presentation of visual images and audible sounds relevant and coordinated to a shopper's “position” within the cybermall.

As a shopper “moves” through the cybermall, graphical images of mall hallways are presented in logical sequence showing store fronts and facades, with selectable areas in the images defining entry points to enter the stores. As stores are entered, specific images of store interiors are provided, allowing each store to control and generate an environment within their own store. During the entire experience, relevant audible sounds are provided to the shopper such as general mall hallway sounds while in the mall, and store-specific background sounds and music while in a selected store.

The navigation, image, and audio facilities are provided by a JAVA applet downloaded to a web browser software to enable the invention to be utilized with a wide variety of web browsing devices and platforms.

### DETAILED DESCRIPTION OF THE INVENTION

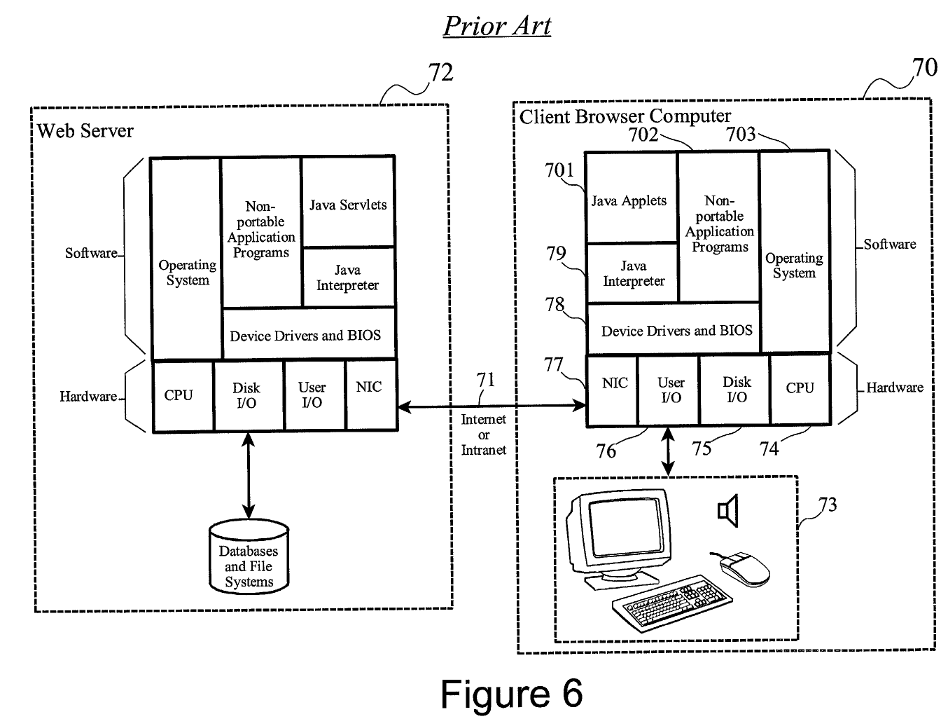

The invention is provided preferably as a platform independent script or program executable by a web browser device. Turning to FIG. 6, the well-known general arrangements of web browser devices (70) and web browser servers (72) are shown. The web server (72) typically includes a web server platform having a central processor unit (CPU), disk subsystem with files and databases, network interface (NIC), and associated software such as an operating system, device drivers, one or more non-portable application programs, and often a number of JAVA servlets and a JAVA interpreter. Such a common web server may be provided with the Apache HTTP web server software and an operating system from IBM, Microsoft or Sun Microsystems.

The most common web browser device is a personal computer including a CPU (76) such as a PowerPC[™] or Pentium[™]; a disk subsystem (75), user interface devices (73) such as a mouse, display, keyboard, and one or more speakers; user 1/0 cards or circuits such as a sound board, display driver, and serial ports; a network interface such as a modem. The browser computer (70) is also often equipped with a BIOS and set of device drivers (78); an operating system such as Linux or Microsoft Windows [™]; one or more non-portable application programs such as a web browser program; and a JAVA interpreter (79) for executing JAVA applets.

In the preferred embodiment, the invention is provided as a JAVA applet and is executable by a wide variety of web browser computer configurations, across many operating systems with different processor types. JAVA is well-known in the programming a web technology arts as it is not a compiled software language, but is rather pseudo-compiled to byte-codes which are machine or processor inspecific. When a JAVA applet is executed by a specific computer on a specific processor with a given operating system, the byte codes are interpreted into machine specific instructions. This allows the JAVA applet to be truly portable across platforms, and consequently has become a very desirable method of implementation for many web applications.

As such, the remaining disclosure of the invention relates to the process, method and functions implemented in a JAVA applet independent of web browser device specifics. However, it will be recognized by those skilled in the art that other programming methodologies may be used to realize the invention in alternate languages.

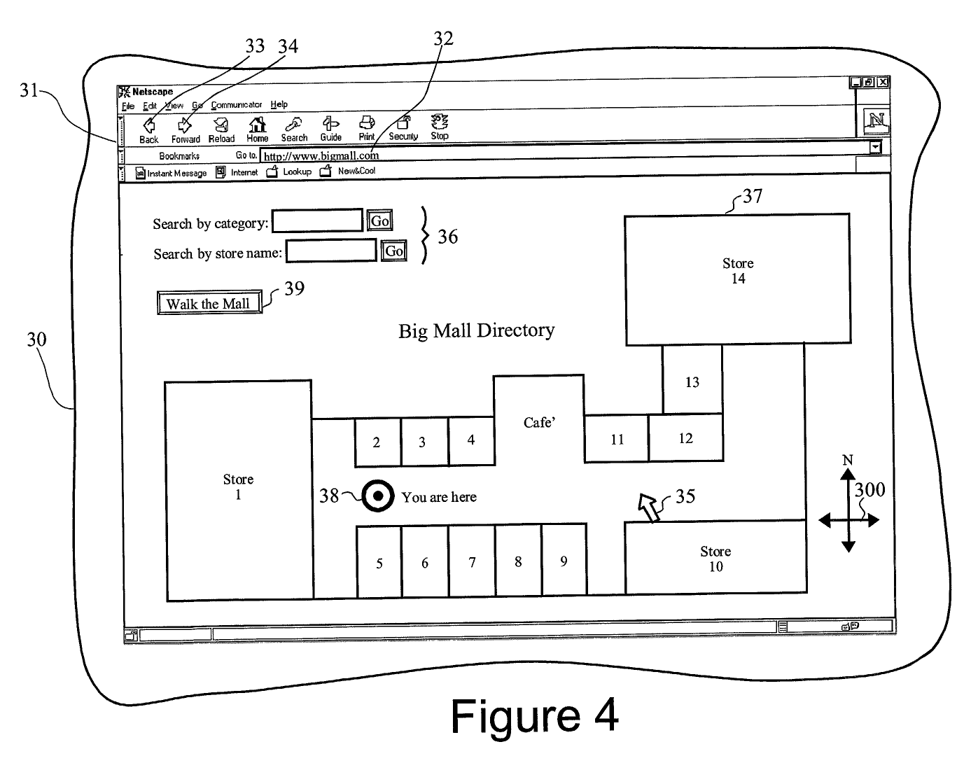

Turning to FIG. 4, the enhanced mall front page provided by the invention is shown. In this view, the mall map (37) is enhanced to included a shopper position indicator (38), and preferably a geographic orientation icon (300). Based upon a current coordinate or position of the “shopper” within the mall, maintained by the JAVA applet, the shopper may see his or her position within the mall floorplan. Preferably, the shopper may “click and drag” the position indicator (38) using the pointer or mouse (37) to move to another position within the mall, or go directly to another position within the mall floorplan by double clicking anywhere in the floorplan.

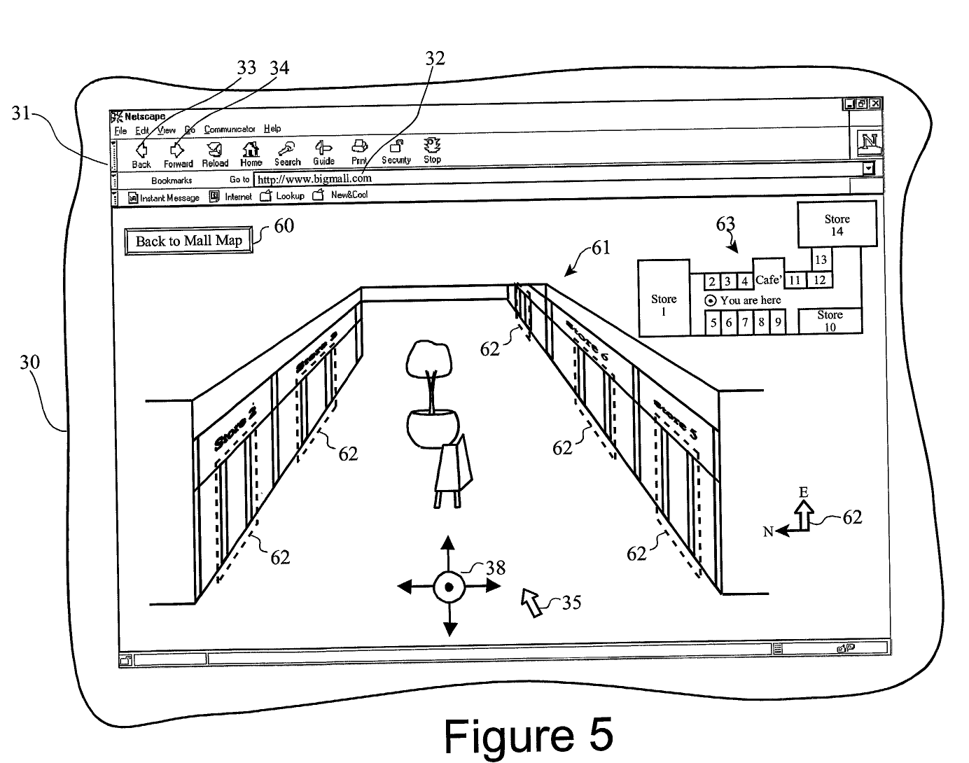

Further, the mall front page is enhanced to include a “walk the mall” button or icon (39), which invokes the multimedia experience of the invention. This could alternatively be invoked by the double clicking action previously described. FIG. 5 shows an example presentation of the visual image from a given position within a mall floor plan, including store facades, and the position indicator (38). The position indicator (38) may be provided with arrows or pointers showing possible directions of movement. A view indicator (62) also may be provided to allow the shopper greater understanding of which direction he or she is “facing” in the cybermall, as well as a miniaturized mall floor plan (63) for more efficient navigation of the cybermall. A button or icon (60) to return to the mall front page is also preferably provided.

From this view, the user or shopper may click and drag the position indicator (38) using the pointer (35), or a combination of keys such as the arrow keys, to move through the mall. As the shopper's position is changed, the presented image is updated accordingly.

The image may be a photograph, such as images taken from within an actual mall, in the form of well-known graphic web objects (GIF, JPEG, etc.), or a simulation of an real view of the mall using vector and/or bit map graphics similar to those used in gaming technologies.

The images are provided with “hot spots” (62) or regions within the images that, when selected, activate a hyperlink to other images or other web pages. Such hot spots may be place over and around store doors, windows, and hallway turns. For example, to enter a particular store, the user could click on the door for the store. Or, to take a direct view into the display window of a store, the user could click on the image of the window. Methods to provide hot spots in graphic images with hyperlinks are well known in HTML and other common web object types.

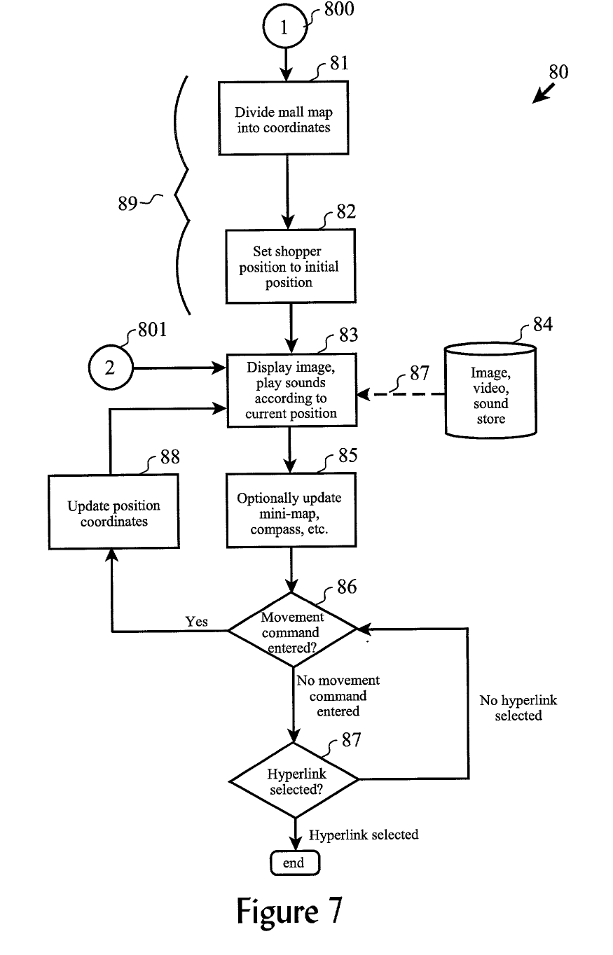

Turning to FIG. 7, the logical process performed by the JAVA applet of the invention is shown. Upon initial visit (800) to the “mall”, the mall floor plan or map is divided into discrete coordinates (81) and the shopper's position is set to an initial position (82) to initialize the shopping session.

During the shopping session, images are displayed and sounds are played (83) by the JAVA applet corresponding to the current position of the shopper in the cybermall floor plan. In the preferred embodiment, this is accomplished by querying a database (84) for relevant image and sound web objects include JPEG and GIF image files and “wave” audio files. These web objects are requested by the JAVA applet from the web server, transmitted (87) from the web server to the JAVA applet, and displayed and played on the web browser devices user interfaces. In an enhanced embodiment, these web objects may include streaming video and/or video clips.

Further according to the preferred embodiment the mini-map display and compass or other directional indicator are updated (85) to reflect the current position within the mall.

Each time a movement command is entered by the shopper, such as pressing an arrow key or dragging the position indicator, the movement command is received (86) by the applet, which then updates the position coordinates of the shopper (88), and subsequently the images and sounds are changed (83) to correspond with the new position. The coordinate system used may be 2-dimensional, such as for a “one story” mall, or multi-dimensional to represent a multi-story mall.

This process continues as the shopper “moves” through the mall, each move causing new images and/or sounds to be retrieved and played to the web browser user, until a hot spot or hyperlink is selected (87), at which time the browser is repointed to the linked address. This may link to a normal web page, such as an ordering or shopping cart page, or may link to another virtual shopping experience JAVA applet, such as entering a store through the “door” on the store's image. In this latter case, a new map, perhaps a detailed map of the interior of a store, may be provided along with presentation of images and sounds relevant to the shopper's position within the store.

Also according to the preferred embodiment, each time a link is selected to another web page or to another virtual shopping session, a record is created of the shopper's last position in the current session, such as by “dropping a cookie” on the shopper's web browser computer. This allows the applet to remember the “exit point” from the current session, in order to allow the shopper to return from the next shopping visit or web page. In this case, when returning to a previous session, the process re-starts from point 2 (801) as shown in FIG. 7, wherein the current position is retrieved from the previous position memory such as by retrieving a cookie from the browser. For example, if a shopper selects a hyperlink to a order entry web page, he may complete the order and then return to the same position in the mall where he left. Or, he may enter a store map through a hot spot on the image of the front of the store, shop throughout a “sub-map” of the interior of the store, and return back “through the front door” into the hallway of the mall by returning to his last position in the previous shopping session.

This allows the invention to be used to “nest” visits to an infinite level, so that malls may be divided in to linked sections, such as upstairs and downstairs, stores can be linked to malls, and departments may be linked to stores. This modularization of the representation of the mall in the preferred embodiment allows the different mall sections, stores and departments to be developed and maintained as separate groups of web objects interrelated by the link definitions. It also lends itself very well to object oriented programming techniques for implementation.

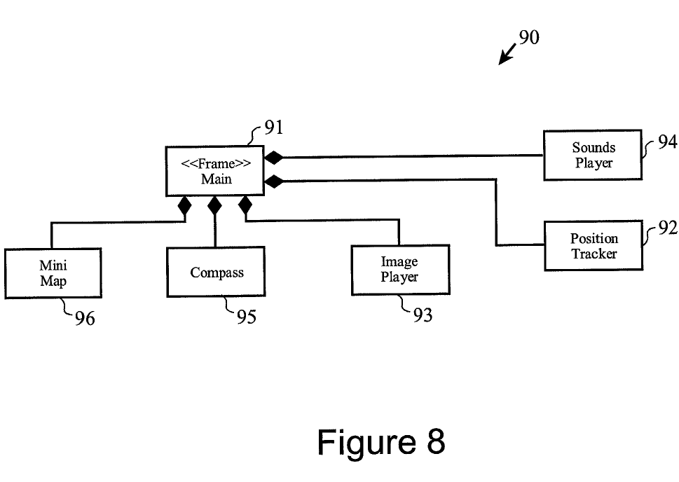

Turning to FIG. 8, the object model of the preferred embodiment using JAVA is shown. The main frame (91) of the web browser receives and runs the JAVA applet, which includes the sounds player object (94), position tracker object (92), and image player object (93). Optionally, it may include the mini-map display object (96) and the compass display object (95). The main frame may invoke any or all of these objects to pass “mouse clicks” to them. The position tracker (92) receives the “mouse clicks”, and resolves the new coordinates of the shopper.

The sounds player (94) periodically requests from a web server any available sound objects such as wave files corresponding to the current coordinates of the shopper.

The image player (93) periodically requests from a web server any available image objects, such as JPEG, GIF, or AVI files, corresponding to the current coordinates of the shopper.

Similarly, the mini-map display (96) and the compass display (95) periodically update their displays based upon the current shopper coordinates.

Alternative to periodic updates, the position tracker may invoke each of the other objects on an event handling basis each time the position is changed.

Using these coordinated, relevant presentations of information (sights, sounds, and maps), the user is given a sense of physical relationship of the stores within the mall, and a sense of the store environment while shopping in the store. For example, while in the “hallways” of an upscale cybermall, the user may hear classical or jazz music and see images of designer flooring, wall treatments, and planters. When entering a nature and science products store, the sounds change to new age music, and the images change to nature and science products displayed on shelves and counter tops. In another mall, perhaps an outlet mall, background audible announcements about specials in various stores may be heard while in the hallway, and when entering a clothing store specializing in outdoor products, nature sounds may be heard.

While specific details of the preferred embodiment and alternate embodiments have been disclosed herein, it will be recognized by those skilled in the art that many substitutions, variations and alternate embodiments may be adopted without departing from the spirit and scope of the invention. For example, other programmnring techniques, web browser platforms, and web object types may be adopted as suitable and as they become available. The scope of this invention should be limited only by the language of the following claims.

What is claimed is:

1. A method of presenting information regarding products, suppliers and offeror to customers in a virtual shopping mall comprising:
providing a map of a virtual shopping mall, said map having a coordinate system associated with positions within the shopping mall;
assigning a customer an initial position having a set of coordinates within the shopping mall;
presenting at least one multimedia object to a customer indexed to said initial position;
updating said initial position to a subsequent position responsive to a position change command from a customer; and
presenting at least one multimedia object to a customer indexed to said subsequent position.

2. The method as set forth in claim 1 wherein said steps of presenting multimedia a object comprise presenting a visual image of a mall or store interior.

3. The method as set forth in claim 2 wherein said steps of presenting a visual image of a mall or store interior further comprise the steps of:
providing a customer-selectable hot spot within said visual image; and
updating said customer's position responsive to selection of said hot spot.

4. The method as set forth in claim 1 wherein said steps of presenting multimedia objects comprise presenting a sound clip representative of background sound within a mall or store interior.

5. A computer readable medium encoded with software causing a computer to perform the following actions:
provide a map of a virtual shopping mall, said map having a coordinate system associated with positions within the shopping mall;
assign a customer an initial position having a set of coordinates within the shopping mall;
present at least one multimedia object to a customer indexed to said initial position;
update said initial position to a subsequent position responsive to a position change command from a customer; and
present at least one multimedia object to a customer indexed to said subsequent position.

6. The computer readable medium as set forth in claim 5 wherein said software for performing the action of presenting a multimedia object comprises software for presenting a visual image of a mall or store interior.

7. The computer readable medium as set forth in claim 6 wherein said software for presenting a visual image of a mall or store interior further comprises software for performing the actions of:
provide a customer-selectable hot spot within said visual image; and
update said customer's position responsive to selection of said hot spot.

8. The computer readable medium as set forth in claim 5 wherein said software for presenting a multimedia object comprises software for presenting a sound clip representative of background sound within a mall or store interior.

9. A shopping mall browser comprising:
a mall map display for showing a customer a geographical organization of a virtual mall contents, said map having a coordinate system associated with positions within the virtual shopping mall;
a customer position initializer for assigning an initial customer having a set of coordinates within the shopping mall;
a position tracker for updating said initial position to a subsequent position responsive to a position change command from a customer; and
a multimedia object presenter for presenting at least one multimedia object to a customer indexed to said initial position or said subsequent position.

10. The shopping mall browser as set forth in claim 9 wherein said multimedia object presenter is adapted to present a visual image of a mall or store interior.

11. The shopping mall browser as set forth in claim 10 wherein said multimedia object presenter is further adapted to provide a customer-selectable hot spot within said visual image and to update a customer position responsive to selection of said hot spot.

12. The shopping mall browser as set forth in claim 9 wherein said multimedia object presenter is adapted to present a sound clip representative of background sound within a mall or store interior.
